(19) United States
(12) Patent Application Publication
(10) Pub. No.: US 2022/0287507 A1
(43) Pub. Date: Sep. 15, 2022

(54) FOLDABLE LID CONNECTABLE TO GRILL GRATE

(71) Applicant: Chris Stephen Manos, Grosse Pointe, MI (US)

(72) Inventor: Chris Stephen Manos, Grosse Pointe, MI (US)

(21) Appl. No.: 17/690,348

(22) Filed: Mar. 9, 2022

Related U.S. Application Data
(60) Provisional application No. 63/159,750, filed on Mar. 11, 2021.

(51) Int. Cl. A47J 37/07

(52) U.S. Cl. CPC A47J 37/0786; A47J 2037/0777

(57) ABSTRACT

A foldable lid for a grill may include a top wall, a front wall, a rear wall, a first side wall, and a second side wall. The front wall may be pivotably coupled to the top wall. The rear wall may be spaced apart from the front wall. The rear wall may be pivotably coupled to the top wall. The first side wall may be pivotably coupled to the rear wall. The second side wall may be spaced apart from the first side wall. The second side wall may be pivotably coupled to the rear wall. The foldable lid may be configured to be in a first configuration or a second configuration.

### CROSS-REFERENCE TO RELATED APPLICATIONS

This application claims priority to U.S. Provisional Application Ser. No. 63/159,750 filed on Mar. 11, 2021, the contents of which are hereby incorporated by reference in their entirety.

### TECHNICAL FIELD

The present disclosure pertains to a foldable lid connectable to a grill grate.

### BACKGROUND

Grills for outdoor cooking, such as barbecue grills, can be very large in size. A user of a grill may desire to store the grill when the grill is not being used. However, to store the grill indoors may require a lot of square footage and, in addition, the large size may make it difficult to move the grill back and forth between storage and use. Additionally, the lid of a grill takes up a lot of this valuable storage space.

Accordingly, there exists a need for an improved lid that requires less space when being stored.

Additionally, some grills come without lids, so there exists a need for a universal lid which can fit and be used with such grills.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present disclosure. Further, the embodiments set forth herein are not intended to be exhaustive or otherwise limit or restrict the claims to the precise forms and configurations shown in the drawings and disclosed in the following detailed description.

FIGS. 1-5 are schematic, perspective views illustrating an exemplary foldable lid at various stages of folding according to teachings of the present disclosure;

FIG. 6 is a schematic exploded/disassembled view of an exemplary grill with a foldable lid according to teachings of the present disclosure;

FIGS. 7-9 are schematic, perspective views illustrating an exemplary foldable lid attached to a grate of a grill at various stages of opening according to teachings of the present disclosure; and

FIG. 10 is a schematic flow diagram of a method of folding an exemplary foldable lid.

### DETAILED DESCRIPTION

An exemplary foldable lid for a grill may include a top wall, a front wall, a rear wall, a first side wall, and a second side wall. The front wall may be pivotably coupled to the top wall. The rear wall may be spaced apart from the front wall. The rear wall may be pivotably coupled to the top wall. The first side wall may be pivotably coupled to the rear wall. The second side wall may be spaced apart from the first side wall. The second side wall may be pivotably coupled to the rear wall. The foldable lid may be configured to be in a first configuration or a second configuration.

An exemplary method for folding a lid for a grill having a front wall, a rear wall, a top wall, a first side wall, and a second side wall collectively defining an interior space while in an assembled configuration may include disengaging the front wall from the first and second side walls, pivoting the front wall relative to the top wall in a direction away from the interior space, pivoting the first and second side walls relative to the rear wall such than inner surfaces of the first and second side walls engage an inner surface of the rear wall, pivoting the rear wall relative to the top wall such that outer surfaces of the first and second side walls engage the inner surface of the top wall and the first and second side walls are disposed between the rear wall and the top wall, and pivoting the front wall relative to the top wall such that an inner surface of the front wall engages the inner surface of the top wall.

An exemplary grill may include a body, a grate, and a foldable lid. The grate may be detachably coupled to the body. The foldable lid may be detachably coupled to the grate. The foldable lid may be configured to pivot relative to the grate.

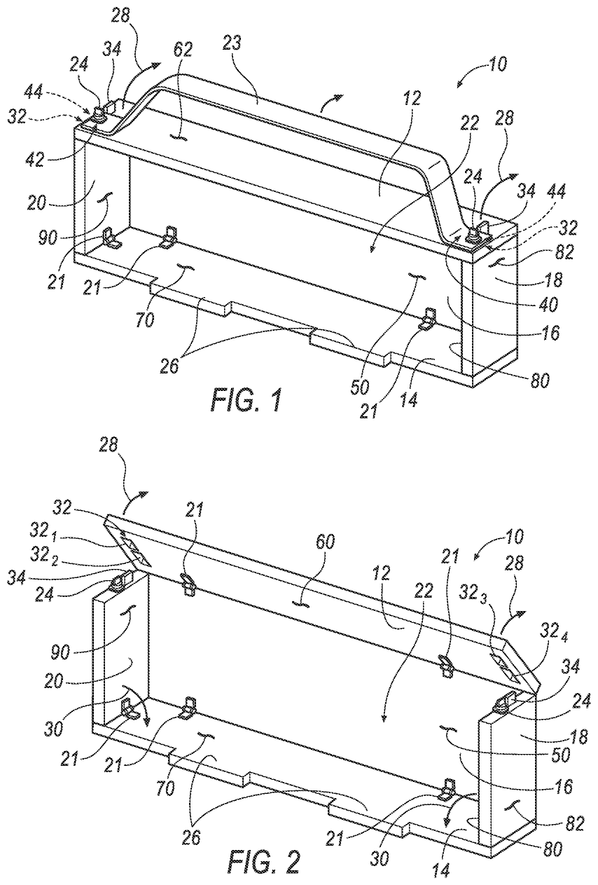

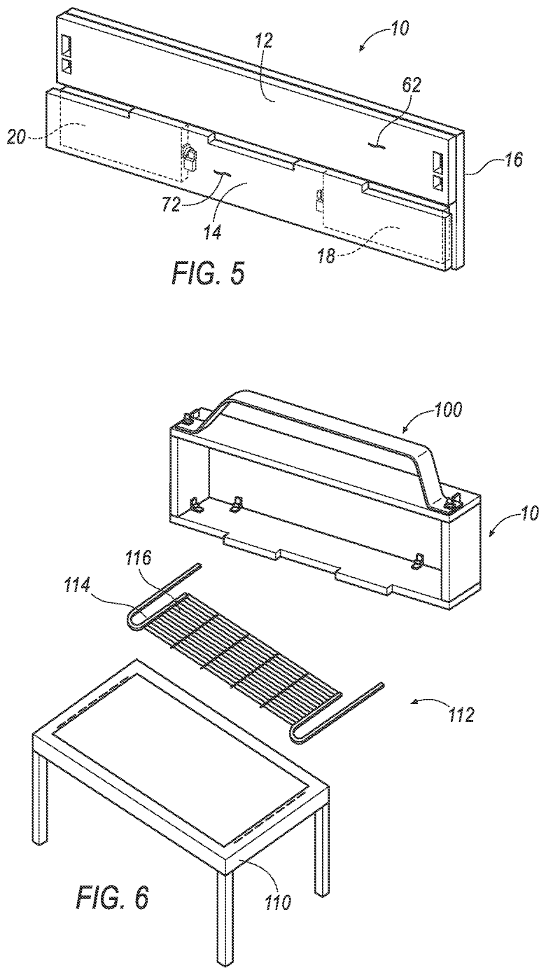

Referring now to the figures, FIGS. 1-5 illustrate an exemplary foldable lid 10 transitioning from a first configuration (e.g., an assembled and/or an operating configuration) (as illustrated in FIG. 1) to a second configuration (e.g., a non-use and/or a storage configuration) (as illustrated in FIG. 5). The foldable lid 10 may include various shapes, sizes, configurations, and/or materials.

The foldable lid 10 may include a front wall 12, a rear wall 14, a top wall 16, a first side wall 18, and a second side wall 20. For example, and without limitation, the top wall 16, the front wall 12, the rear wall 16, and the first and second side walls 18, 20 may comprise a metal material and/or any other suitable material that is configured to withstand heat that is produced during the operation of the grill.

As illustrated in figures, the front wall 12 may be pivotably coupled to the top wall 16. The rear wall 14 may be spaced apart from the front wall 12 and may be pivotably coupled to the top wall 16. The first side wall 18 may pivotably coupled to the rear wall 14. The second side wall 20 may be spaced apart from the first side wall 18 and may pivotably coupled to the rear wall 14. Alternatively, the first and second side walls 18, 20 may be pivotally coupled to the front wall 12 and/or the top wall 16. The foldable lid 10 is configured to be in a first configuration (e.g., a non-use and/or a storage configuration) or a second configuration (e.g., a non-use and/or a storage configuration).

The top wall 16 may include an inner surface 50 and an opposing outer surface 52. The front wall 12 may include an inner surface 60 and an opposing outer surface 62. The rear wall 14 may include an inner surface 70 and an opposing outer surface 72. The first side wall 18 may include an inner surface 80 and an opposing outer surface 82. The second side wall 20 may include an inner surface 90 and an opposing outer surface 92.

For example, and without limitation, the front wall 12 may be attached to the top wall 16 via one or more hinges 21. The rear wall 14 may be attached to the top wall 16 via one or more hinges 21. The first side wall 18 may be attached to the rear wall 14, the front wall 12, and/or the top wall 16 via hinges 21. The second side wall 20 may be attached to rear wall 14, the front wall 12, and/or the top wall 16 via hinges 21. In some examples, in lieu of hinges, the lid 10 may incorporate straps, bands, clips, locks, among others, to attach the front wall 12, the rear wall 14, the top wall 16, and/or the side walls 18, 20.

In some example configurations, the first and second side walls 18, 20 may or may not be attached to the top wall 16. If attached, the side walls 18, 20 may be releasably attached, for example, but not limited, to, via fasteners, adhesives, clips, tabs, and the like. If not attached, the side walls 18, 20 may stay in an extended/unfolded position via engagement with the front wall 12 or rear wall 14 and/or via a locking mechanism, for example, but not limited to, locking linkages. It should be appreciated that variations of the configuration of the front wall 12, rear wall 14, the top wall 16, and/or the side walls 18, 20 with respect to one another is contemplated herein.

Referring now to FIG. 2, in some example configurations, the front wall 12 may include a plurality of voids 32, such as a first void 32₁, a second void 32₂, a third void 32₃, and a fourth void 32₄. The voids 32 may be disposed proximate terminal ends of the front wall 12. For example, the first and second voids 32₁₋₂ may be disposed proximate one terminal end and the third and fourth voids 32₃₋₄ may be disposed proximate the other terminal end. Alternatively, the rear wall 14 may include the plurality of voids 32 in a similar manner as illustrated for the front wall 12.

In some examples, the first and second side walls 18, 20 may each include one or more extensions 34 and one or more fasteners 24. The extensions 34 and fasteners 24 may extend from side surfaces (e.g., the surface disposed between the inner surface 80, 92 and the outer surface 82, 92) of the first and second side walls 18, 20. The extensions 34 and/or the fasteners 24 may be configured to fit within and/or aligned with corresponding voids 32 of the front wall 12 or the rear wall 14. As illustrated in the figures, when the lid 10 is arranged in the first configuration, an extension 34 of the first side wall 18 may be disposed at least partially within the fourth void 32₄ of the front wall 12, and a fastener 24 of the first side wall 18 may be disposed at least partially within the third void 32₃ of the front wall 12. An extension 34 of the second side wall 20 may be disposed at least partially within the second void 32₂ of the front wall 12, and a fastener 24 of the second side wall 20 may be disposed at least partially within the first void 32₁ of the front wall 12.

For example, but without limitation, the extensions 34 may include a locking mechanism. A locking mechanism may include a clip, a tab, or any other type of securing/locking mechanism known in the art. A locking mechanism may be configured to latch onto a surface (e.g., outer surfaces 62, 72) of the front or rear walls 12, 14. In some examples, the extensions 34 may be flexible. The fasteners 24 are shown as twist lock fasteners. However, it should be appreciated that, in some example configurations, a fastener 24 may include a locking pin, a knob, and/or any other type of securing/locking mechanism known in the art.

The extensions 34 and/or the fasteners 24 may be configured to lock and/or secure the first and second side walls 18, 20 to the front wall 12 or rear wall 14 such as to lock the foldable lid 10 into the first configuration. For instance, when the fasteners and/or the extensions are in a locked state, the front wall 12, the rear wall 14, and the first and second side walls 18, 20 are prevented from moving relative to the top wall 16.

Referring now to FIG. 1, the foldable lid 10 is shown in the first configuration (e.g., an assembled and/or an operating configuration). In some examples, the foldable lid 10 may include a handle 23. The handle 23 may be connected to the lid 10 in the first configuration and may be removed from lid 10 in the second configuration. The handle 23 may be detachably coupled to the front wall 12 (e.g., via the fasteners 24). In some instances, the handle 23 may be detachably coupled to a side wall 18, 20 or the top wall 16. In some examples, the foldable lid 10 may include one or more handles 23. For instance, a first handle may be connected to the first side wall 18 and a second handle may be connected to second side wall 20.

As illustrated in FIG. 1, the handle 23 includes a first end 40 and a second end 42 spaced apart from the first end 40. The first and second ends 40, 42 may each include a void 44 that is aligned with a corresponding void 32 of the front wall 14 and a fastener 24. For instance, in the first configuration, the fastener 24 of the first side wall 18 is disposed within the third void 32₃ of front wall 12 and the void 44 of the first end 40 of the handle 23, and the fastener 24 of the second side wall 20 is disposed within the first void 32₁ of front wall 12 and the void 44 of the second end 42 of the handle 23. The handle 23 may be detachably connected to the front wall 12 via the fasteners 24. For instance, a user/operator may manipulate (e.g., twist/rotate a portion of a fastener, etc.) the fasteners 24 such as change the fastener 24 from an unlocked state to a locked state or a locked state to an unlocked state. The handle 23 may be removed from the foldable lid 10 when the fasteners 24 are in an unlocked state.

In some example configurations, the handle 23 may be detachably connected to the foldable lid 10 via the extensions 34. In some examples, the handle 23 may be detachably connected to the foldable lid 10 via the extensions 34 and the fasteners 24. For instance, the first and second ends 40, 42 of the handle 23 may each include at least two voids that are aligned with a corresponding extension and fastener.

With continued reference to FIG. 1, in the first configuration, the top wall 16, the front wall 12, the rear wall 14, and the first and second side walls 18, 20 collectively define an interior space 22. The interior space 22 is accessible via an exposed bottom portion of the foldable lid 10. In some instances, the front wall 12, the rear wall 14, and the first and second side walls 18, 20 extend from the top wall 16. The front wall 12, the rear wall 14, and the first and second side walls 18, 20 may extend orthogonal relative to the top wall 16. The first side wall 18 may be disposed between and connected to the front wall 12 and the rear wall 14. The second side wall 20 may be disposed between and connected to the front wall 12 and the rear wall 14.

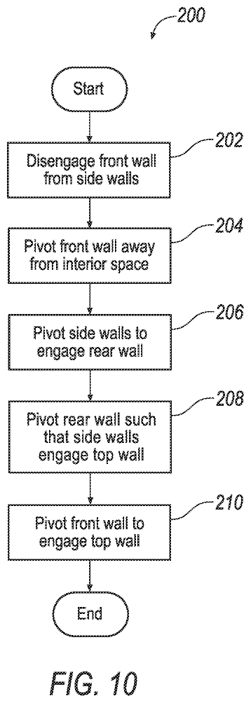

Referring now to FIG. 10, an exemplary method 200 for folding a lid 10 for a grill from a first configuration (e.g., an assembled and/or an operating configuration) to a second configuration (e.g., a non-use and/or a storage configuration) is shown. Method 200 generally may begin at step 202 in which the front wall 12 is disengaged from the first and second side walls 18, 20. Step 202 may include unlocking (e.g., changing the fasteners 24 from a locked state to an unlocked state) and/or removing the fasteners 24 such that the handle 23 can be removed from the front wall 12. Step 202 may include removing the handle 23 from the lid 10. In some examples, when the fasteners 24 are in an unlocked state and the handle 23 has been removed from the lid 10, the front wall 12 is able to be moved relative to the side walls 18, 20 and/or top wall 16.

After step 202, method 200 may proceed to step 204 in which the front wall 12 is pivoted relative to the top wall 16 in a direction 28 away from the interior space 22, as illustrated in FIG. 2. The front wall 12 is pivoted such that the inner surface 60 of the front wall 12 is spaced away from (e.g., no longer in contact with) the first and second side walls 18, 20.

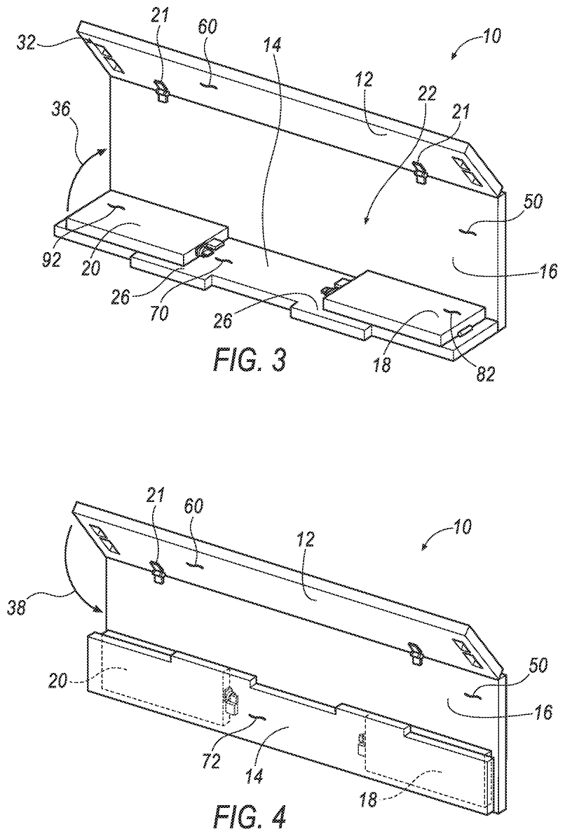

After step 204, the method 200 may proceed to step 206, in which the first and second side walls 18, 20 are pivoted (e.g., folded) relative to the rear wall 14 (e.g., in direction 30) such that inner surfaces 80, 90 of the first and second side walls 18, 20 engage the inner surface 70 of the rear wall 14, as illustrated in FIGS. 2 and 3.

After step 206, the method 200 may proceed to step 208, in which the rear wall 14 is pivoted (e.g., folded) relative to the top wall 16 (e.g., in direction 36) such that outer surfaces 82, 92 of the first and second side walls 18, 20 engage the inner surface 50 of the top wall 16 and the first and second side walls 18, 20 are disposed between the rear wall 14 and the top wall 16, as illustrated in FIGS. 3 and 4.

After step 208, the method 200 may proceed to step 210, in which the front wall 12 is pivoted (e.g., folded) relative to the top wall 16 (e.g., in direction 38) such that the inner surface 60 of the front wall 12 engages the inner surface 50 of the top wall 16, as illustrated in FIGS. 4 and 5.

Referring now to FIG. 5, the foldable lid 10 is shown in the second configuration (e.g., a non-use and/or a storage configuration). The folding of the lid 10 reduces its size in all dimensions, and therefore makes the storage of the lid 10 (and a grill of which it is a part) easier and/or space-saving. As illustrated, the inner surface 60 of the front wall 12 is in contact with the inner surface 50 of the top wall 16. The inner surfaces of the 80, 90 of the first and second side walls 18, 20 are in contact with the inner surface 70 of the rear wall 14. The outer surfaces 82, 92 of the first and second side walls 18, 20 are in contact with the inner surface 50 of the top wall 16. The first and second side walls 18, 20 are disposed between the rear wall 14 and the top wall 16. The front wall 12, the rear wall 14, and the first and second side walls 18, 20 are arranged such as to substantially cover an inner surface 50 of the top wall 16. For instance, approximately the entire inner surface 50 of the top wall 16 is covered.

Referring now to FIG. 6, an exemplary grill 100 that incorporates the foldable lid 10 is illustrated. The grill 100 may be any kind of grill, including, but not limited to, a rotisserie grill, a propane grill, etc. The grill 100 generally may include a body 110 that defines a lower portion of an interior space (e.g., interior space 22), the lid 10, which defines an upper portion of an interior space, and a grate 112 that sits on and/or is secured to the body 110. The grate 112 generally may include at least a series of longitudinal bars 114 with gaps 116 therebetween.

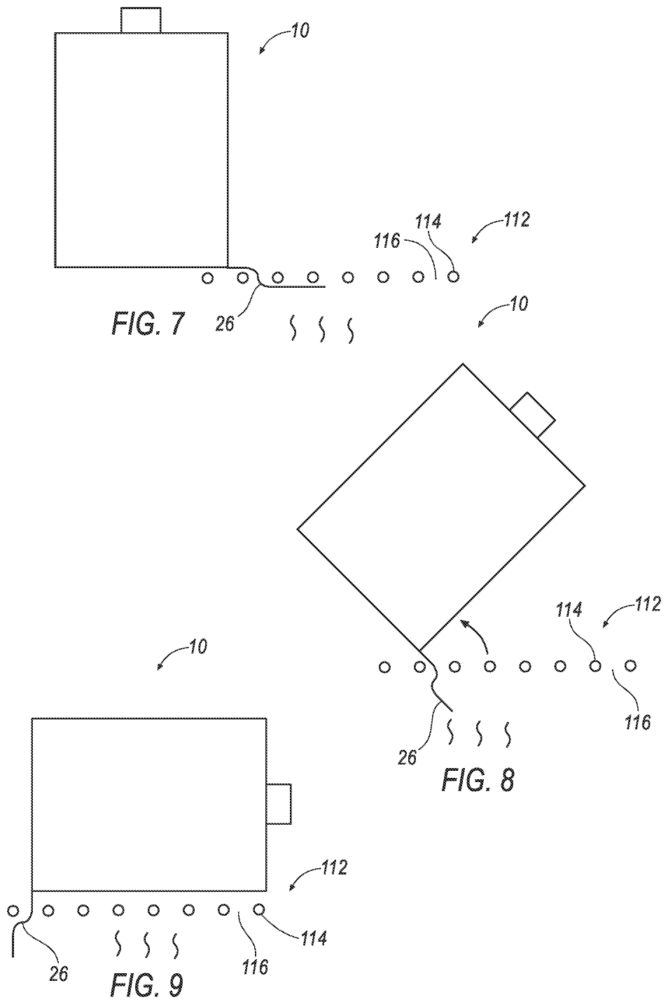

Referring now to FIGS. 7-9, the lid 10 generally may be pivotably coupled to and/or secured to the grate 112. In embodiments, the lid 10 may include one or more brackets 26 extending from the rear wall 14. The bracket(s) 26 may be removably (via fasteners) or permanently (e.g., welded) to the rear wall 14. Alternatively, the brackets 26 may be formed as a unitary structure with the rear wall 14 (e.g., cut from a single piece of metal).

The bracket(s) 26 generally may be insertable into at least one gap 116 between adjacent longitudinal bars 114 of the grate 112, and shaped such that when inserted, at least a portion of the bracket(s) 26 may engage with at least one of the longitudinal bars 114. For example, and without limitation, as seen in FIGS. 7-9, the bracket(s) 26 may have a bent configuration such that in a fully open position (FIG. 7), a portion of the bracket(s) 26 sit on top of longitudinal bar(s) 114 while another, offset portion engages with an under-portion of different longitudinal bar(s) 114. As the lid 10 is opened and closed, a bent portion of the bracket(s) 26 may rotate along one of the longitudinal bars 114. In the closed position, the lid 10 may then rest directly on the longitudinal bars 114 and/or the body 110 of the grill. It should be appreciated that other known mechanisms for detachably/releasably and rotatably attaching/securing the lid 10 to the grate 112 is contemplated, including, but not limited, embodiments in which the bracket(s) 26 are attached directly to one of the longitudinal bars 114 and rotates therearound, and therefore is not inserted through one of the gaps 116.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A foldable lid for a grill, the lid comprising:
a top wall;
a front wall pivotably coupled to the top wall;
a rear wall spaced apart from the front wall and pivotably coupled to the top wall;
a first side wall pivotably coupled to the rear wall; and
a second side wall spaced apart from the first side wall and pivotably coupled to the rear wall;
wherein the foldable lid is configured to be in a first configuration or a second configuration.

2. The foldable lid of claim 1, including a handle detachably coupled to the front wall;
wherein the handle includes a first end and a second end spaced apart from the first end; and
wherein the handle is connected to the foldable lid in the first configuration and is detached from the lid in the second configuration.

3. The foldable lid of claim 2, including a first fastener and a second fastener;
wherein the first fastener extends from the first side wall and the second fastener extends from the second side wall.

4. The foldable lid of claim 3, wherein:
the first fastener is configured to secure the first end of the handle to the front wall; and
the second fastener is configured to secure the second end of the handle to the front wall.

5. The foldable lid of claim 1, including at least one bracket extending from the rear wall.

6. The foldable lid of claim 5, wherein a portion of the bracket is configured to engage a grate of the grill such that the foldable lid is pivotable relative to the grate.

7. The foldable lid of claim 5, wherein the at least one bracket is formed as a unitary structure with the rear wall.

8. The foldable lid of claim 5, wherein the at least one bracket is detachably coupled to the rear wall.

9. The foldable lid of claim 1, wherein, in the first configuration, the top wall, the front wall, the rear wall, and the first and second side walls collectively define an interior space; and
wherein the interior space is accessible via an exposed bottom portion of the foldable lid.

10. The foldable lid of claim 1, wherein, in the first configuration, the front wall, the rear wall, and the first and second side walls extend orthogonal relative to the top wall.

11. The foldable lid of claim 1, wherein, in the first configuration, the first side wall is disposed between and connected to the front wall and the rear wall; and
the second side wall is disposed between and connected to the front wall and the rear wall.

12. The foldable lid of claim 1, wherein, in the second configuration, an inner surface of the front wall engages an inner surface of the top wall.

13. The foldable lid of claim 1, wherein, in the second configuration, an inner surface of the first side wall engages an inner surface of the rear wall; and
an inner surface of the second side wall engages the inner surface of the rear wall.

14. The foldable lid of claim 1, wherein, in the second configuration, an outer surface of the first side wall engages an inner surface of the top wall; and
an outer surface of the second side wall engages the inner surface of the top wall.

15. The foldable lid of claim 1, wherein, in the second configuration, the first and second side walls are disposed between the top wall and the rear wall.

16. The foldable lid of claim 1, wherein, in the second configuration, the front wall, the rear wall, and the first and second side walls are arranged to substantially cover an inner surface of the top wall.

17. A method for folding a lid for a grill having a front wall, a rear wall, a top wall, a first side wall, and a second side wall collectively defining an interior space while in an assembled configuration, the method comprising:
disengaging the front wall from the first and second side walls;
pivoting the front wall relative to the top wall in a direction away from the interior space;
pivoting the first and second side walls relative to the rear wall such than inner surfaces of the first and second side walls engage an inner surface of the rear wall;
pivoting the rear wall relative to the top wall such that outer surfaces of the first and second side walls engage the inner surface of the top wall and the first and second side walls are disposed between the rear wall and the top wall; and
pivoting the front wall relative to the top wall such that an inner surface of the front wall engages the inner surface of the top wall.

18. The method of claim 17, including removing a handle from the lid.

19. The method of claim 18, including unlocking one or more fasteners prior to removing the handle.

20. A grill, comprising:
a body;
a grate detachably coupled to the body; and
a foldable lid according to claim 1;
wherein the foldable lid is detachably coupled to the grate; and wherein the foldable lid is configured to pivot relative to the grate.
